(19) United States
(12) Patent Application Publication
(10) Pub. No.: US 2014/0007197 A1
(43) Pub. Date: Jan. 2, 2014

(54) DELEGATION WITHIN A COMPUTING ENVIRONMENT

(71) Applicant: Michael John Wray, Bath (GB)

(72) Inventor: Michael John Wray, Bath (GB)

(21) Appl. No.: 13/537,721

(22) Filed: Jun. 29, 2012

(51) Int. Cl. G06F 21/24

(52) U.S. Cl. 726/4

(57) ABSTRACT

In one implementation, a delegation system authenticates, at a first time, a first user relative to a computing environment, and receives, at a second time after the first time, a request for the first user to act within the computing environment as a second user. The delegation system also determines, in response to the request, whether the first user is authorized to act as the second user within the computing environment. The delegation system then receives an action request from the first user, identifies the second user as an effective user for the action request; and provides the action request to the computing environment,

### BACKGROUND

Computing environments typically include resources such as storage volumes, directories, files, and hardware devices that are accessible to some users and inaccessible to other users. Various access mechanisms such as permissions, access control lists (ACLs), and capabilities are used to authorize individual users or groups of users to access resources within a computing environment.

Some computing environments include a delegation mechanism that allows a user to access resources that were previously in accessible to that user. Such delegation mechanisms can be useful to allow one user to modify resources of another user, but can be cumbersome to manage and result in undesirable results within the computing environment.

### BRIEF DESCRIPTION OF THE DRAWINGS

FIG. 1 is a flowchart of a delegation process, according to an implementation.

FIG. 2 is a schematic block diagram of an environment including a delegation system and a computing environment, according to an implementation.

FIG. 3 is a schematic block diagram of a delegation system hosted at a computing system, according to an implementation.

FIG. 4 is a data flow diagram of delegation relative to a computing environment, according to an implementation.

FIG. 5 is a schematic block diagram of another environment including a delegation system and a computing environment, according to another implementation.

FIG. 6 is a flowchart of another delegation process, according to another implementation.

### DETAILED DESCRIPTION

Some delegation mechanisms used by computing environments modify permissions, ACLs, capabilities, or other access mechanisms associated with resources to allow one user to access resources that were previously inaccessible to that user. For example, an owner of a directory (e.g., a user that presently has access to the directory) can modify an ACL of a directory to allow another user to access that directory. The other user can then, for example, modify files within the directory, create files within the directory, or delete files within the directory. Typically, the actions (or operations) such as modifying, creating, and deleting files, for example, are attributed to the other user. That is, the computing environment identifies the other user as the entity that performed the actions.

Such delegation mechanisms can have a variety of disadvantages. For example, files created within the directory can be inaccessible to the owner of the directory unless an ACL of those files is modified to authorize the owner of the directory to access those files. Additionally, in some computing environments, it is desirable that all actions within the directory be attributed to the owner of the directory. Maintaining the ACLs and attribution for resources within computing environments using such delegation mechanisms can be complex and error-prone.

Other delegation mechanisms used by computing environments allow a user to authenticate as another user to perform actions as the other user. Continuing the directory example from above, the user can supply a credential such as, for example, a password, digital certificate, or encryption key associated with the other user (here, the owner of the directory) to the computing environment to authenticate with the computing environment as the other user. The user can then, as above, modify files within the directory, create files within the directory, or delete files within the directory because the user has authenticated with (or logged into) the computing environment as the other user, to which the directory is accessible. Typically, these actions are attributed to the other user also because the user has authenticated with the computing environment as the other user.

Although such delegation mechanisms overcome some disadvantages of other delegation mechanisms, the user must have access to a credential associated with the other user. Such access can be undesirable and even prohibited by some security policies.

Delegation systems and methods discussed herein allow a user to act within a computing environment as another user without authenticating as the other user. Moreover, such delegation systems and methods do not rely on modification of permissions, ACLS, capabilities, or other access mechanisms of or associated with resources of the computing environment to allow the user to access resources that are accessible to the other user, but otherwise inaccessible to the user. Said differently, rather than have authorization to access particular resources, the user is authorized to act as the other user. In other words, the user is not authorized to access particular resources, but may be authorized to act as the other user. When the user is acting as the other user, the computing environment functions as though the other user is performing actions. Accordingly, such delegation systems and methods allow the user to function as an agent of the other user within the computing environment such that the user can access resources as the other user and such access is attributed to the other user.

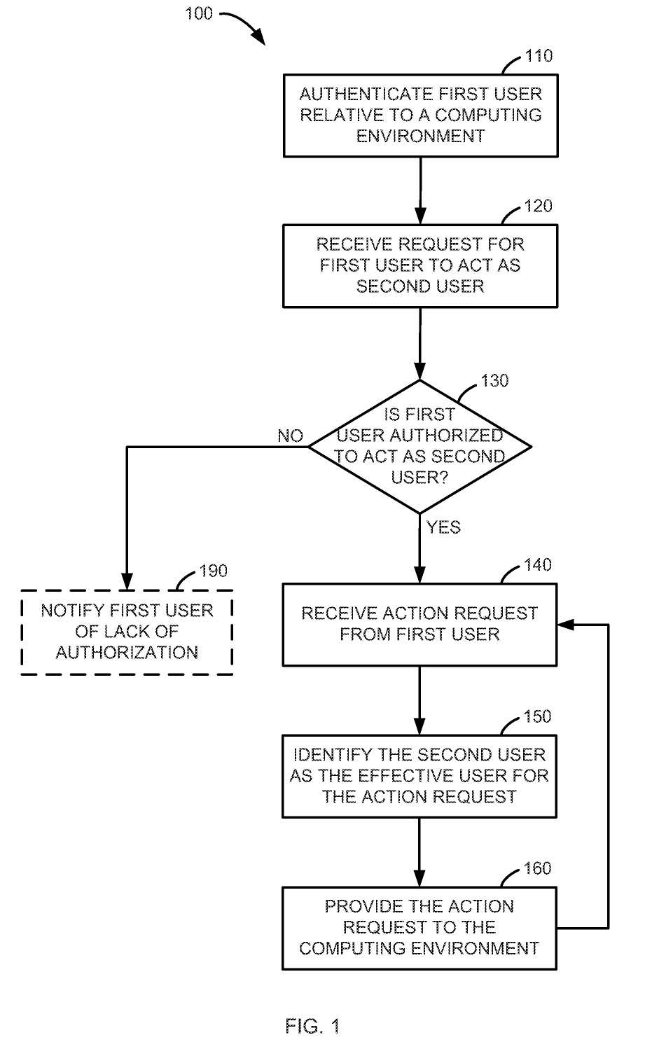

FIG. 1 is a flowchart of a delegation process, according to an implementation. Process 100 can be implemented at a computing system such as a computer server or within a distributed computing system such as a cloud computing environment. Accordingly, process 100 can be performed at a single computer server, or some blocks or steps of process 100 can be performed at one computer server and other blocks or steps of process 100 can be performed at another computer server or other computer servers. As a specific example, a delegation system implementing process 100 can be hosted at a gateway via which clients (or users) can access a web application (or other computing environment).

A first user is authenticated for a computing environment at block 110. A user is an entity (e.g., an agent such as a person or process—software hosted at a computing system) that accesses or uses a computing environment. A computing environment is one or more computing systems and/or software hosted thereon that implement a service. For example, a web application hosted at a distributed computing system is a computing environment. Such a computing environment can be referred to as a cloud computing environment. As another example, an operating system hosted at a computing system is a computing environment.

Typically, a computing environment includes or supports user accounts. A user can authenticate relative to the computing environment to log into a context associated with the user account of that user within the computing environment. A context includes one or more processes and/or data within the computing environment that allow the user to interact with the computing environment.

Referring to block 110, the first user can be authenticated relative to the computing environment by receiving an identifier of the first user (or user identifier) and a credential of the first user from the first user. The identifier of the user can be, for example, an identifier such as a username or user number associated with a user account within the computing environment. The credential of the user can be, for example, a digital certificate, encryption key, a cookie (i.e., a data set previously provided to a client such as an Internet or web browser hosted at a computing system to identify the user), or a password associated with the user account. In some implementations, the user identifier and credential can be provided to the delegation system implementing process 100 via an encrypted channel. For example, the delegation system can be hosted at a gateway that communicates with clients via the Secure Hypertext Transfer Protocol (HTTPS).

The delegation system implementing process 100 can compare the user identifier and credential with corresponding values in a user account database or file, for example, associated with the computing environment. If the user identifier and credential received from the first user match the corresponding values for a user account in the user account database, the first user can be authenticated. That is, the delegation system can determine that the first user is the user associated with that user account of the computing environment.

In some implementations, the values stored at the user account database that correspond to a user identifier and/or a credential are obscured or modified relative to the user identifier and credential received from the first user. For example, the value stored at the user account database that corresponds to a credential can be a securely or cryptographically hashed version of the credential. Accordingly, the delegation system can modify the user identifier and/or credential received from the first user to authenticate the first user. Moreover, in some implementations, a user can be authenticated based on data included within a digital certificate and/or an exchange of encrypted data between the delegation system and a client associated with the user.

After the first user is authenticated relative to the computing environment at block 110, the first user can be said to have logged into (or onto) the computing environment. That is, a context within the computing environment exists for the first user, and the first user can request actions relative to resources within the computing environment. In other words, the first user can access resources within the computing environment.

As discussed above, in some computing environments a user does not have access to all the resources within those computing environments. Often, it can be useful to have a user access a resource within a computing environment that is generally not accessible to the user. Moreover, in some implementations, a user is an agent that performs some action (or task) on behalf of a user. For example, in a cloud computing environment, software agents can provision storage volumes, modify file systems, or perform other tasks on behalf of other users. Often, providing such agents with super-user or administrative privileges (e.g., full access to all the resources within a computing environment) can be undesirable.

As discussed in more detail herein, delegation systems and methods disclosed herein allow users (also referred to as authorizing users) to authorize other users (such as agents and also referred to as agent users) to request that the delegation system perform actions requested by an agent users as a particular authorizing user. Thus, the agent user need not authenticate a subsequent time using, for example, a credential associated with an authorizing user or that agent user. Rather, the agent user has a permission or capability granted by an authorizing user (or a super-user) to request that the delegation system request actions within the computing environment as the authorizing user. Accordingly, from the perspective of the computing environment, such actions requested by the agent user are requested by the authorizing user, and the computing environment performs the actions as though the authorizing user requested those actions.

At block 120, a request for the first user to act as a second user is received at a delegation system implementing process 100. For example, returning to the example of a delegation system hosted at a gateway that communicates with the first user (or a client associated with the first user) via HTTPS, the request for the first user to act as a second user can be a Hypertext Transfer Protocol (HTTP) header key/value pair, in which the key indicates the request and the value is a user identifier of the second user. In other implementations, the request can be of various other forms.

A delegation system implementing process 100 then determines, at block 130, whether the first user is authorized to act or request actions within the computing environment as the second user. For example, the delegation system can access user account information for the first user or the second user and associated with the computing environment to determine whether the first user s authorized to act as the second user. In some implementations, information indicating that the first user is authorized to act as the second user is stored in a database or file indexed by user identifier. As one example, the delegation system can access a list of users authorized to act as the second user, and the first user is authorized to act as the second user if a user identifier of the first user is included in the list. Alternatively, the delegation system can access a list of users as which the first user is authorized to act, and the first user is authorized to act as the second user if a user identifier of the second user is included in the list.

In other implementations, the delegation system can provide a user identifier of the first user, a user identifier of the second identifier, and a clause or identifier to indicate an “act as” attribute to a theory-based authorization module. The theory-based authorization module can determine whether the first user holds that attribute relative to the second user, and provide an indication that the first user is or is not authorized to act as the second user.

If the first user is not authorized to act as the second user at block 130, process 100 is complete. In some implementations, as illustrated in FIG. 1, the delegation system implementing process 100 provides a notification to the first user to indicate the lack of authorization. In some implementations, the first user can be logged out or unauthenticated relative to the computing environment if the first user requests to act as a second user for which the first user is not authorized to act.

If the first user is authorized to act as the second user at block 130, process 100 proceeds to block 140 at which process 100 waits for a request for an action (or action request) within the computing environment from the first user. After an action request is received from the first user at block 140, the delegation system implementing process 100 identifies the second user as the effective user for the action associated with the action request at block 150. As used herein, an effective user of an action is the user to which the computing environment attributes actions. As a specific example, an effective user of an action (or action request) is the user the computing environment interprets as the source of a request to perform or performance of an action.

The second user can be identified as the effective user using a variety of methodologies. For example, the delegation system can define or set the second user as the effective user of the context of the first user within the computing environment. As another example, the delegation system can access or generate an identifier associated or associable with the second user, and modify the action request to include that identifier. As a specific example, the delegation system can access or generate a token that identifies the second user as the effective user for the action request and include that token in the action request.

The action request is provided to the computing environment at block 160. As used here, a modified copy of an action request can be referred to as that action request. Accordingly, it should be understood that if an action request is received from a first user and a copy of the action request is modified to identify a second user as the effective user for the action request within a computing environment, the modified copy can also be referred to as “the action request” if a common action is described by the originally received action request and the modified copy thereof.

As an example of providing an action request to the computing environment, a gateway at which the delegation system implementing process 100 is hosted can communicate via a communications link such as a communications network with a group of computing systems that host the computing environment. The delegation system can provide the action request to the computing environment via the communications network. In some implementations, one or more computing systems can be virtualized computing systems, and the communications network can be a virtualized communications network. As a specific example, the gateway hosting the delegation system can communicate with the computing systems hosting the computing environment via HTTP or HTTPS, and the action request can be provided to the computing environment via HTTP or HTTPS, respectively. In other implementations, the action request can be provided to the computing environment via other protocols or methodologies.

Because the second user was previously identified as the effective user for the action request (or for the action associated with the action request) within the computing environment, the computing environment performs the action described by or associated with the action request as though the action request was provided by the second user. Accordingly, the action is attributed to the second user within the computing environment. Thus, within the computing environment, modifications and accesses to resources appear to have been performed by or at the request of the second user. Thus, an agent user acting as an authorizing user can perform actions on behalf of the authorizing user without affecting the consistency of the resources (e.g., resource permissions, access histories or logs, and ownership or creatorship information). Moreover, complex methodologies or schemas to provide the agent user with accesses to the resources of the authorizing user need not be adopted. Rather, as discussed above, the authorizing user authorizes the agent user to act as the authorizing user within the computing environment.

Process 100 illustrated in FIG. 1 is an example implementation of a delegation process. In other implementations, a delegation process can include more, fewer, or rearranged steps. For example, in some implementations, a request for the first user to act as the second user is included within or is implicit to an action request. That is, blocks 120 and 140 can be performed as a single step or block. As another example, in some implementations, block 150 can be performed after block 130 and before block 140. As a specific example, if the first user is authorized to act as the second user at block 130, the second user is defined as the effective user of the context of the first user within the computing environment before an action request is received at block 140. In other implementations, a token associable with the second user is generated after block 130 and before block 140, and action requests received from the first user are modified to include that token to identify the second user as the effective user of the action request within the computing environment.

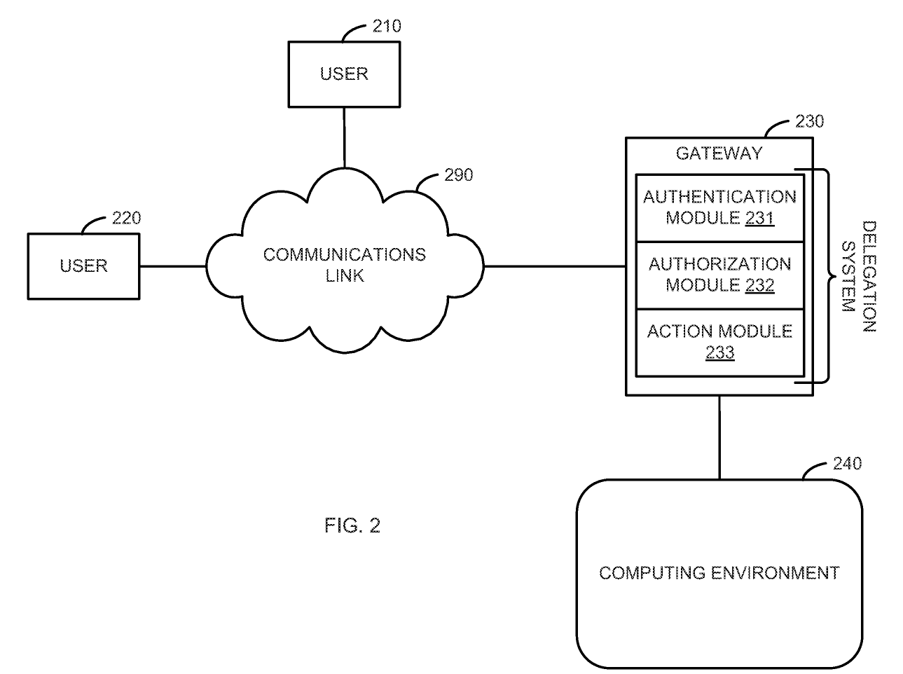

FIG. 2 is a schematic block diagram of an environment including a delegation system and a computing environment, according to an implementation. Although various modules (i.e., combinations of hardware and software) are illustrated and discussed in relation to FIGS. 2-4 and other example implementations, other combinations or sub-combinations of modules can be included within other implementations. Said differently, although the modules illustrated in FIGS. 2-4 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

The environment illustrated in FIG. 2 includes user 210, user 220, gateway 230, computing environment 240, and communications link 290. In some implementations, user 210 and/or user 220 communicate with gateway 230 (or with computing environment 240 via gateway 230) using a client. For example, if user 210 is a person, user 210 can communicate with gateway 230 using an Internet browser or other application hosted at a computing system such as a notebook computer, desktop computer, smartphone, or tablet device.

Gateway 230 is a module such as a dedicated computer server, a computing appliance, or virtual machine and software hosted thereon via which users access computing environment 240. For example, gateway 230 can authenticate users relative to computing environment 240 and marshal action requests and action responses (or results) between users and computing environment 240. In some implementations, gateway 230 is hosted at a separate computing system from a computing system hosting computing environment 240. For example, gateway 230 can be hosted at a cluster of computer servers and computing environment 240 can be hosted at a distributed or cloud computing service. In other implementations, at least some components or elements (e.g., modules) of gateway 230 are hosted at a common computing system with computing environment 240.

As discussed above, computing environment 240 is a service or application accessible to users via gateway 230. For example, computing environment 240 can be a web application, a cloud computing (e.g., compute, storage, database, or combination thereof) service, or some other computing environment accessible to users.

Communications link 290 includes devices, services, or combinations thereof that define communications paths between users 210 and 220 (or clients via which users 210 and 220 access gateway 230), gateway 230, and/or other devices or services (not shown). For example, communications link 290 can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Communications link 290 can include communications networks such as an intranet, the Internet, other telecommunications networks, or a combination thereof. Additionally, communications link 290 can include proxies, routers, switches, gateways, bridges, load balancers, and similar communications devices. Furthermore, the connections and communications paths (e.g., between communications link 290 and users 210 and 220 and gateway 230) illustrated in FIG. 2 are logical and do not necessarily reflect physical connections.

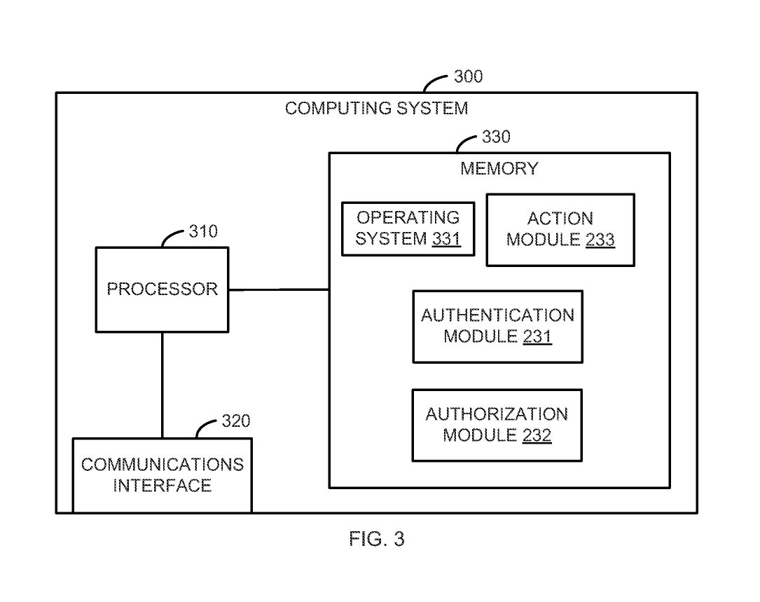

Gateway 230 includes a delegation system including authentication module 231, authorization module 232, and action module 233. FIG. 3 is a schematic block diagram of a delegation system hosted at a computing system, according to an implementation. That is, gateway 230 can be a computing system such as computing system 300 illustrated at FIG. 3.

In the example illustrated in FIG. 3, computing system 300 includes processor 310, communications interface 320, and memory 330. Processor 310 is any combination of hardware and software that executes or interprets instructions, codes, or signals. For example, processor 310 can be a microprocessor, an application-specific integrated circuit (ASIC), a distributed processor such as a cluster or network of processors or computing systems, a multi-core or multi-processor processor, or a virtual or logical processor of a virtual machine,

Communications interface 320 is a module via which processor 310 can communicate with other processors or computing systems via communications link. For example, communications interface 320 can include a network interface card and a communications protocol stack hosted at processor 310 (e.g., instructions or code stored at memory 330 and executed or interpreted at processor 310 to implement a network protocol) to receive and send action requests. As specific examples, communications interface 320 can be a wired interface, a wireless interface, an Ethernet interface, a Fiber Channel interface, an InfiniBand interface, and IEEE 802.11 interface, or some other communications interface via which processor 310 can exchange signals or symbols representing data to communicate with other processors or computing systems.

Memory 330 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 330 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 330 can represent multiple processor-readable media. In some implementations, memory 330 can be integrated with processor 310, separate from processor 310, or external to computing system 300.

Memory 330 includes instructions or codes that when executed at processor 310 implement operating system 331 and a delegation system including authentication module 231, authorization module 232, and action module 233.

In some implementations, computing system 300 can be a virtualized computing system. For example, computing system 300 can be hosted as a virtual machine at a computing server. Moreover, in some implementations, computing system 300 can be a virtualized computing appliance, and operating system 331 is a minimal or just-enough operating system to support (e.g., provide services such as a communications protocol stack and access to components of computing system 300 such as communications interface 320) authentication module 231, authorization module 232, and action module 233.

The delegation system including authentication module 231, authorization module 232, and action module 233 can be accessed or installed at computing system 300 from a variety of memories or processor-readable media. For example, computing system 300 can access a delegation system at a remote processor-readable medium via communications interface 320. As a specific example, computing system 310 can be a network-boot device that accesses operating system 330, authentication module 231, authorization module 232, and action module 233 during a boot sequence.

As another example, computing system 300 can include (not illustrated in FIG. 3) a processor-readable medium access device (e.g., CD, DVD, SD, MMC, or a CF drive or reader), and can access authentication module 231, authorization module 232, and action module 233 at a processor-readable medium via that processor-readable medium access device. As a more specific example, the processor-readable medium access device can be a DVD drive at which a DVD including an installation package for one or more of authentication module 231, authorization module 232, and action module 233 are accessible. The installation package can be executed or interpreted at processor 300 to install one or more of authentication module 231, authorization module 232, and action module 233 at computing system 300 (e.g., at memory 330). Computing system 300 can then host or execute one or more of authentication module 231, authorization module 232, and action module 233.

In some implementations, authentication module 231, authorization module 232, and action module 233 can be accessed at or installed from multiple sources, locations, or resources. For example, some of authentication module 231, authorization module 232, and action module 233 can be installed via a communications link, and others of authentication module 231, authorization module 232, and action module 233 can be installed from a DVD.

In other implementations, authentication module 231, authorization module 232, and action module 233 can be distributed across multiple computing systems. That is, some of authentication module 231, authorization module 232, and action module 233 can be hosted at one computing system and others of authentication module 231, authorization module 232, and action module 233 can be hosted at another computing system. As a specific example, authentication module 231, authorization module 232, and action module 233 can be hosted within a cluster of computing systems where each of authentication module 231, authorization module 232, and action module 233 is hosted at multiple computing systems, and no single computing system hosts each of authentication module 231, authorization module 232, and action module 233.

Referring to FIG, 2, authentication module 231 authenticates users relative to computing environment 240. For example, authentication module 231 receives user identifiers and credentials, and determines whether a user account corresponding to a particular user identifier and credential pair exists for the computing environment,

Authorization module 232 determines whether a first user is authorized to act or perform (or request) actions as a second user within a computing environment. As discussed above, authorization module 232 can determine whether a first user is authorized to act as a second user within a computing environment using permissions, capabilities, or other authorization methodologies. Furthermore, as discussed above, authorization module 232 can determine whether a first user is authorized to act as a second user without receiving a credential associated with the second user from the first user. Said differently, authorization module 232 can determine that a first user is authorized to act as a second user independent of a credential of the second user.

In some implementations, authorization module 232 identifies an authorizing user as an effective user of an action request received from an agent user. For example, authorization module 232 can define the authorizing user as the effective user of the action request or can generate a token associable with the authorizing user.

Moreover, in some implementations, authorization module 232 determines whether an authorizing user is authorized to perform an action described by an action request received from an agent user. For example, after determining that an agent user is authorized to act as an authorizing user within computing environment 240, authorizing module 232 can access ACLs, permissions, or capabilities to determine whether the authorizing user is authorized to access a resource and/or perform an action requested by the agent user. In other implementations, mechanisms within computing environment 240 can determine whether the authorizing user Is authorized to access a resource and/or perform an action requested by the agent user. Moreover, in some implementations, authorization module 232 can be distributed across gateway 230 (or a delegation system hosted at gateway 230) and computing environment 240. In other words, some functionalities of authorization module 232 can be performed at gateway 230 and other functionalities of authorization module 232 can be performed at computing environment 240.

Action module 233 requests actions to be performed as an authorizing user within computing environment 240 based on action requests received from an agent user. For example, action module 233 can provide HTTP requests to computing environment 240 for which an authorizing user is identified as the effective user to perform an action described in an action request. In other words, action module 233 can forward an action request (or modified copy thereof as discussed above) to computing environment 240.

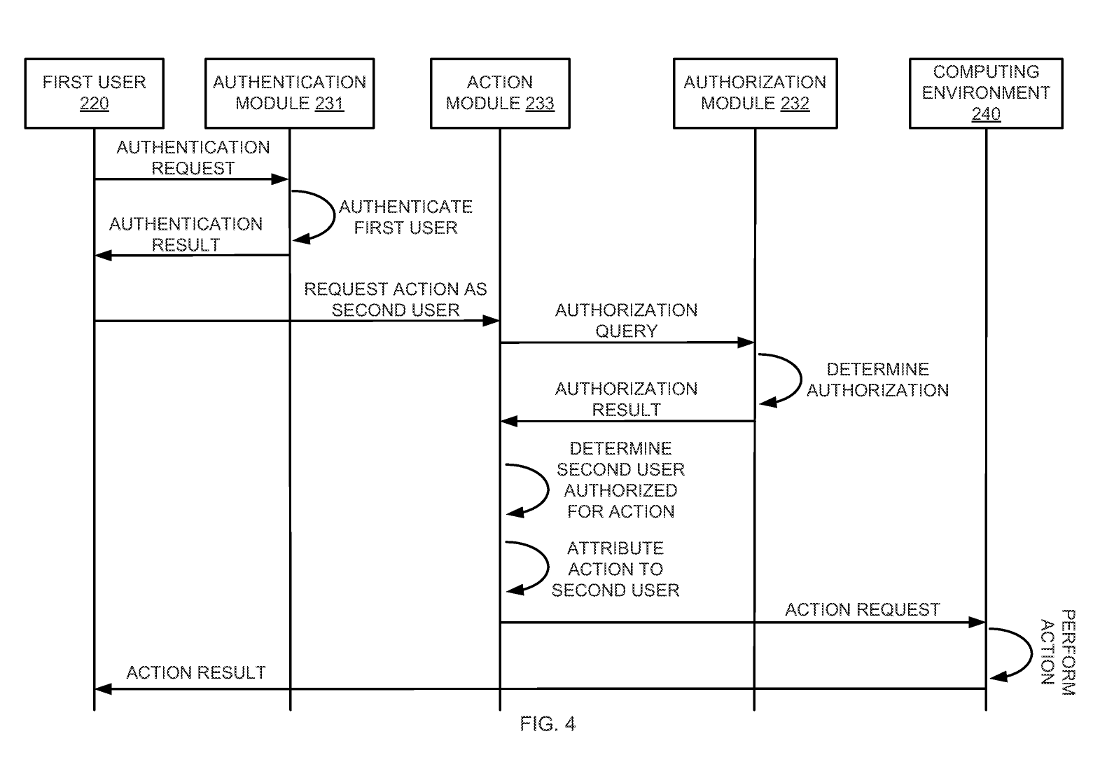

As an example of a delegation process, FIG. 4 is a data flow diagram of delegation relative to a computing environment, according to an implementation. The reference numbers in FIG. 4 correspond to those of FIG. 2. In other implementations, a delegation process can apply to other topologies or arrangements. Moreover, in other implementations, communications illustrated in FIG. 4 between two particular entities can flow between other entities.

As illustrated in FIG. 4, first user 220 provides an authentication request to authentication module 231 to be authenticated with or to log into computing environment 240. First user 220 is authenticated at authentication module 231 and authentication module 231 provides an authentication result (e.g., indicating that first user 220 was or was not authenticated). First user 220 then requests an action as a second user (e.g., user 210 in FIG. 2).

First user 220 can request an action as a second user by sending an action request to action module 233 that describes or identifies the action and the second user. For example, the action request can include a unique number (or code) and parameters or arguments that identify an action and a user identifier of the second user. As a specific example, the action can be described in the body portion of an HTTP GET or POST request, and the user identifier can be included within a header portion of the HTTP GET or POST request. As another example, first user 220 can provide a first request to action module 233 that identifies the second user, and a second request that identifies an action (or a group of subsequent requests that identify actions) to be performed as the second user.

In response to the action request, action module 233 provides an authorization query (or request) to authorization module 232 to determine whether first user 220 is authorized to act as or perform the action as the second user. Authorization module 232 can determine whether first user 220 is authorized to act as or perform the action as the second user using a variety of methodologies and/or mechanisms. For example, as discussed above, authorization module 232 can access permissions, capabilities, ACLs, or other mechanisms to determine whether first user 220 is authorized to act as or perform the action as the second user.

In some implementations, authorizations to act as another user can be handled or managed for a computing environment using a common system that is used to handle or manage access to resources within that computing environment. As a specific example, ACLs can be used within a computing environment to manage authorization for access to resources such as files within the computing environment, and a user account for each user of the computing environment can include an ACL indicating which other users are authorized to act as that user and/or indicating for which other users that user is authorized to act. Thus, a common authorization system or methodology can be used to manage access to resources and which users are authorized to act for which other users.

After determining whether first user 220 is authorized to act as or perform an action as the second user, authorization module 232 provides an authorization result to action module 233. If first user 220 is not authorized to act as or perform an action as the second user, action module 233 can provide a result (not shown in FIG. 4) to first user 220 indicating that first user 220 is not authorized to act as or perform an action as the second user.

If first user 220 is authorized to act as or perform an action as the second user, action module 233 determines whether the second user is authorized to perform the action. For example, action module 233 can determine whether the second user is authorized to access a resource within computing environment 240 identified in the action request received from first user 220. In some implementations, action module 233 communicates with authorization module 232 to determine whether the second user is authorized to perform the action. For example, similar to the authorization query provided in response to the request for first user 220 to act as the second user, action module 233 can provide an authorization query to authorization module 232, authorization module 232 can determine whether the second user is authorized to perform the action, and authorization module 232 can provide an authorization result to indicate whether the second user is authorized to perform the action.

If the second user is not authorized to perform the action, action module 233 can provide a notification to first user 220 indicating that the second user is not authorized to perform the action. If the second user is authorized to perform the action, action module 233 can attribute the action to the second user. For example, the second user can be defined or set as the effective user of a context within computing environment 240 that was established or instantiated in response to first user 220 logging into computing environment 240. As another example, action module 233 can modify the action request to identify the second user as the effective user of the action request. In other implementations, action module 233 attributes the action to the second user using other methodologies or mechanisms.

Action module 233 then provides an action request to computing environment 240 to request that the action be performed (or to perform the action) as the second user within computing environment 240. The action is performed, and a result of the action is provided to first user 220.

As illustrated in FIG. 4, action module 233 attributes the action to the second user before the action is performed within computing environment 240. Thus, rather than perform the action within computing environment 240 as first user 220 and then modifying computing environment 240 to attribute the action to the second user, action module 233 (or some other component or element of delegation systems and methods discussed herein) identifies the second user as the effective user of the action such that from the perspective of computing environment 240 the action is originally performed (or requested to be performed) by the second user.

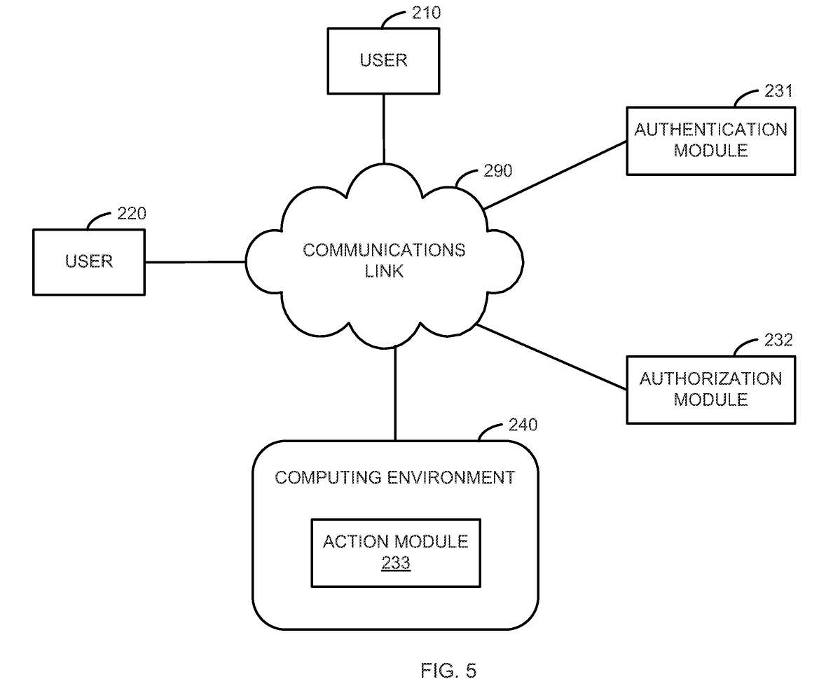

As illustrated in FIG. 5, a delegation system can be distributed, rather than hosted at a common computing system such as gateway 230 illustrated in FIG. 2. FIG. 5 is a schematic block diagram of another environment including a delegation system and a computing environment, according to another implementation. The environment illustrated in FIG. 5, similar to FIG. 2, includes users 210 and 220, computing environment 240, authentication module 231, authorization module 232, action module 233, and communications link 290.

However, in the example illustrated in FIG. 5, authentication module 231, authorization module 232, and action module 233 are distributed (i.e., hosted at separate computing systems) and in communication one with another (and with users 210 and 220) via communications link 290. In other implementations, other topologies or arrangements are possible. For example, authentication module 231 and/or authorization module 232 can also be included as parts or components of computing environment 240.

As an example of the operation of the topology or arrangement illustrated in FIG. 5, user 220 can access computing environment 240 to log into computing environment 240. Computing environment 240 can receive a user identifier and credential of user 220, and forward the user identifier and credential of user 220 to authentication module 231 to authenticate user 220. As an alternative, computing environment 240 can redirect user 220 (or a client user 220 uses to access computing environment 240) to authentication module 231 to authenticate user 220 relative to computing environment 240. Authentication module 231 can provide an indication to user 220 and/or computing environment 240 (e.g., a cookie or other data set) to show or demonstrate that user 220 has been authenticated relative to computing environment 240.

User 220 can then provide an action request to computing environment 240 to request an action within computing environment 240 be performed as user 210. Computing environment 240 can communicate with authorization module 232 to determine whether user 220 is authorized to perform the action as user 210, and, in some implementations, whether user 210 is authorized to perform the action.

If user 220 is authorized to act as user 210 and user 210 is authorized to perform the action, action module 233 performs the action as user 210. As used herein, an action module or a delegation system performs an action by providing one or more commands, instructions, or requests to effect the action within a computing environment. Thus, an action module can request an action based on an action request provided by an agent user for which an authorizing user rather than the agent user is the effective user. Alternatively, for example in the implementation illustrated in FIG. 5, the action module can be included within or be part of the computing environment, and the action module can issue commands or instructions within the computing environment to effect the action.

Because the action is performed with user 210 as the effective user of the action, the effects of the action on computing environment 240 indicate that user 210 rather than user 220 performed the action. For example, ownership information, access information, modification information, and/or other information that can be updated within computing environment 240 based on or as a result of the action indicates that user 210 performed the action. Said differently, the action is attributed within computing environment 240 to user 210.

In some implementations, action module 231 or another component of a delegation system can maintain a log of actions requested by an agent user (user 220 in this example) and performed within computing environment 240 as an authorizing user (user 210 in this example). That is, a record related to each such action and identifying the agent user, the authorizing user, the action, some combination thereof, and/or additional information can be stored at a data store,

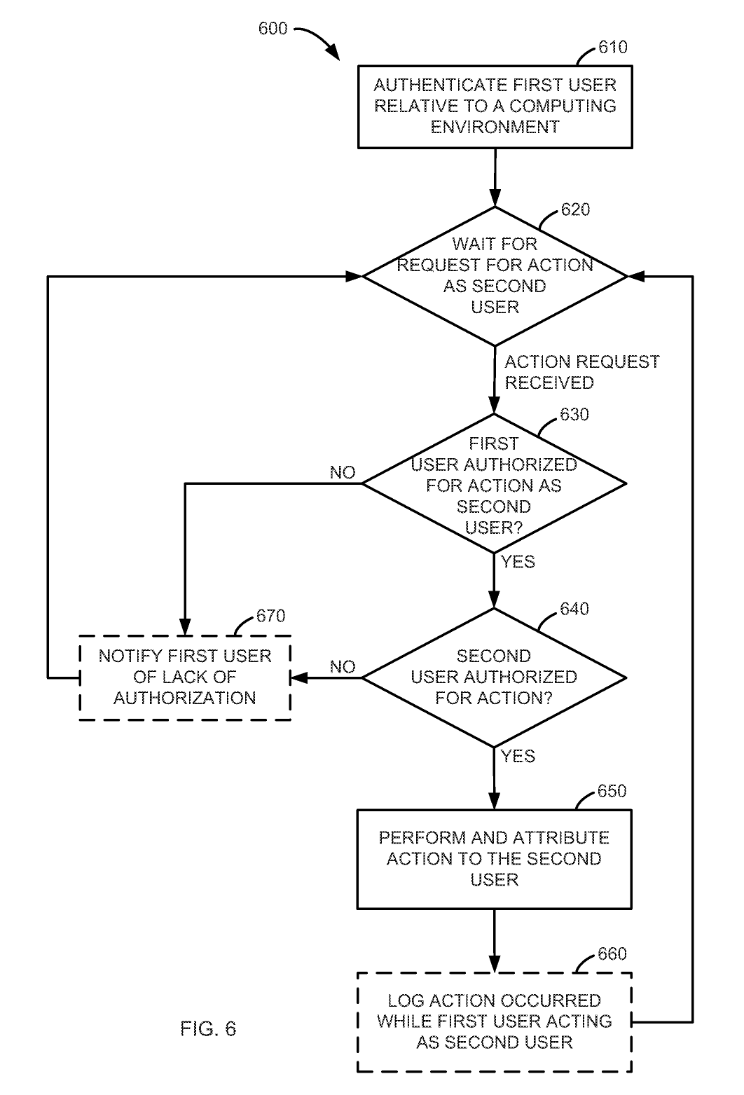

FIG. 6 is a flowchart of another delegation process, according to another implementation. Similar to process 100 illustrated in FIG. 1, process 600 can be implemented at a computing system such as a computer server or within a distributed computing system such as a cloud computing environment. Additionally, process 600 illustrated in FIG. 6 is an example implementation of a delegation process. In other implementations, a delegation process can include more, fewer, or rearranged steps. Some examples of such variations are specifically discussed herein.

A first user is authenticated relative to a computing environment at block 610, and process 600 (or a delegation system implementing process 600) waits at block 620 for a request to perform an action as a second user. After an action request is received at block 620, process 600 proceeds to block 630, at which the delegation system implementing process 600 determines whether the first user is authorized to request or perform an action described or identified in the action request as the second user (e.g., a user identified in the action request). In this example implementation, the first user can be separately authorized to act as the second user for each of a variety of actions. For example, the first user can have a permission (or right) that authorizes the first user to perform a file create action, but not a permission for a file read, a permission for a file modify, or a permission for a file delete action. As another example, separate entries in an ACL for a user can separately indicate which users are authorized to perform (or request) particular actions as that user. Said differently, the first user can be authorized to act as the second user for a particular action or a group of particular actions. Thus, authorization to perform actions as another user can be granularly allocated to a user. Such implementations can allow fine-grain control of the actions users authorized to perform (or request) as other users.

If the first user is authorized to perform the action as the second user at block 630, process 600 proceeds to block 640, at which the delegation system implementing process 600 determines whether the second user is authorized to request or perform the action described or identified in the action request. If the first user is not authorized to perform the action as the second user at bock 630 or the second user is not authorized to perform the action at block 640, process 600 returns to block 620 to wait for another action request. In some implementations, as illustrated in FIG. 6, the user is notified of the lack of authorization at block 670 before process 600 returns to block 620.

If the second user is authorized to perform the action, the action is performed and attributed to the second user within the computing environment. As discussed above, the action is attributed to the second user such that the action is originally performed within the computing environment as the second user. That is, the action is not performed within the computing environment and the computing environment subsequently modified to attribute the action to the second user. Rather, for example, the second user is defined as the effective user of a content of the first use (e.g., a context initialized in response to block 610) within computing environment. As another example, the delegation system implementing process 600 can attribute the action to the second user by identifying the second user as the effective user in an action request provided to the computing environment from the delegation system. More specifically, for example, the delegation system can include a user identifier of or other identifier or token associated or associable with the second user.

Process 600 then returns to block 620 to wait for additional action requests. In some implementations, as illustrated in FIG. 6, the delegation system implementing process 600 can log that the action occurred while the first user was acting as the second user. Accordingly, records in, for example, a log file can be reviewed to determine whether an action (or the results thereof) attributed to the second user was performed while the first user was acting as the second user.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data to a computing system or agent via a communications path or channel), pull mechanisms (e.g., delivering data to a computing system or agent in response to a request from the computing system or agent), and store mechanisms (e,g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
authenticate, at a first time, a first user relative to a computing environment;
receive, at a second time after the first time, a request for the first user to act within the computing environment as a second user;
determine, in response to the request, whether the first user is authorized to act as the second user within the computing environment;
receive an action request from the first user;
identify the second user as an effective user for the action request; and
provide the action request to the computing environment.

2. The processor-readable medium of claim 1, further storing code representing instructions that when executed at the processor cause the processor to store a plurality of records associated with action requests received from the first user, each record from the plurality of records identifying the first user, the second user, and an action request associated with that record.

3. The processor-readable medium of claim 1, further storing code representing instructions that when executed at the processor cause the processor to define the second user as an effective user of a context of the first user within the computing environment.

4. The processor-readable medium of claim 1, wherein determining whether the first user is authorized to act as the second user within the computing environment is independent of a credential associated with the second user.

5. The processor-readable medium of claim 1, wherein the first user is not authorized to perform an action associated with the action request within the computing environment if the first user is not authorized to act as the second user,

6. The processor-readable medium of claim 1, wherein an action associated with the action request is attributed to the second user within the computing environment in response to the action request.

7. The processor-readable medium of claim 1, wherein the processor is at a computing system different from a computing system at which the computing device is hosted.

8. A delegation system, comprising:
an authentication module to authenticate a first user relative to a computing environment;
an authorization module to determine whether the first user is authorized to perform an action as a second user within the computing environment; and
an action module to receive an action request identifying the action from the first user, to identify the second user as an effective user for the action request, and to provide the action request to the computing environment if the authorization module determines that the first user is authorized to perform the action as the second user.

9. The system of claim 8, wherein the authorization module is configured to determine whether the first user is authorized to perform the action as the second user in response to a request for the first user to perform the action as the second user.

10. The system of claim 8, wherein the authorization module is configured to determine whether the first user is authorized to perform the action as the second user independent of a credential associated with the second user.

11. The system of claim 8, wherein the authorization module is configured to define the second user as an effective user of a context of the first user within the computing environment

12. The system of 8, wherein the action module is configured to determine whether the second user is authorized for the action before performing the action within the computing environment.

13. The system of claim 8, wherein:
the action is a first action;
the action request is a first action request;
the authorization module is configured to determine whether the first user is authorized to perform a second action different from the first action as the second user within the computing environment; and
the action module is configured to receive a second action request identifying the second action from the first user, to identify the second user as an effective user for the second action request, and to provide the second action request to the computing environment if the authorization module determines that the first user is authorized to perform the second action as the second user.

14. The system of claim 8, wherein the authentication module, authorization module, and action module are configured to be hosted at a computing system different from a computing system at which the computing environment is hosted,

15. A delegation method, comprising:
authenticating a first user relative to a computing environment;
determining, independent of a credential associated with a second user, that the first user is authorized to act within the computing environment as the second user; and
identifying the second user as an effective user for action requests received from the first user to attribute actions associated with the action requests within the computing environment to the second user; and
providing the action requests to the computing environment.

16. The method of claim 15, further comprising determining, before the identifying, that the second user is authorized to perform the action.

17. The method of claim 15, wherein the identifying includes defining the second user as an effective user of a context of the first user within the computing environment.

18. The method of claim 15, wherein the first user is not authorized to perform the action within the computing environment,
